(19) United States
(12) Patent Application Publication
(10) Pub. No.: US 2021/0262289 A1
(43) Pub. Date: Aug. 26, 2021

(54) Ladder Safety Device

(71) Applicant: A & R Technologies & Safety Ltd., Ardrossan (CA)

(72) Inventor: Richard Milton, Gibbons (CA)

(21) Appl. No.: 17/316,472

(22) Filed: May 10, 2021

Related U.S. Application Data
(62) Division of application No. 15/634,391, filed on Jun. 27, 2017, now abandoned.

(30) Foreign Application Priority Data
Jul. 14, 2016 (CA) 2936214

(51) Int. Cl. E06C 7/48

(52) U.S. Cl. CPC E06C 7/488; E06C 7/48

(57) ABSTRACT

A ladder safety device is provided for supporting a ladder with side rails and rungs. The ladder safety device has a ladder enclosure with a front, side supports, a rear support, and a ladder rung engagement that extends from the rear support toward the front. A mounting element is provided for mounting the ladder enclosure to a surface. The ladder enclosure defines a receiving area sized to permit the side rails and rungs of the ladder to pass therethrough and a support area with side rail receptacles that are open to the receiving area and receive the side rails of the ladder on either side of the ladder rung engagement such that one of the rungs of the ladder directly overlies the ladder rung engagement. The support area is accessed by inserting the ladder through the receiving area, and moving the ladder into the support area.

### TECHNICAL FIELD

This relates generally to safety equipment for working at elevation, and more particularly, to a ladder safety device for retaining a ladder.

### BACKGROUND

When working on a roof or other elevated surface, a ladder is often used to reach the surface, and the person working may stand on the ladder as they complete the work. A variety of factors such as uneven ground, wind, or the user moving on the ladder may result in undesired movement of the ladder. This may pose a safety hazard to the person using the ladder, as they may fall or otherwise be injured, as well as to the surrounding environment. It may also cause a delay in work if a person on an elevated surface is unable to climb down as their ladder has fallen. One example of a ladder support device is shown in US Patent Application Publication No. 2015/02041440.

### SUMMARY

According to an aspect, there is provided a ladder safety device for supporting a ladder, the ladder having side rails connected by rungs spaced along a height of the ladder, the ladder safety device comprising a ladder enclosure having a front, side supports, a rear support, and a ladder rung engagement that extends from the rear support toward the front, the ladder enclosure defining a ladder receiving area and a ladder support area, wherein the ladder receiving area is sized to permit the side rails and rungs of the ladder to pass therethrough along the height of the ladder, and the ladder support area comprises side rail receptacles defined on either side of the ladder rung engagement by the rear support and the side supports, the side rail receptacles being open to the ladder receiving area and sized to receive the side rails of the ladder such that one of the rungs of the ladder directly overlies the ladder rung engagement, wherein the ladder support area is accessed by inserting the ladder through the ladder receiving area, and moving the ladder into the ladder support area from the ladder receiving area, and a mounting element for mounting the ladder enclosure to a surface.

According to another aspect, the front of the ladder enclosure may comprise a front support.

According to another aspect, each of the front support and the rear support may be length-adjustable.

According to another aspect, the ladder rung engagement may comprise a section of the rear support that is offset into the ladder enclosure.

According to another aspect, the mounting element may permit pivotal movement of the ladder enclosure relative to the surface.

According to an aspect, there is provided the combination of a ladder having side rails connected by rungs spaced along a height of the ladder, a ladder safety device comprising a ladder enclosure having a front, side supports, a rear support, and a ladder rung engagement that extends from the rear support toward the front, the ladder enclosure defining a ladder receiving area and a ladder support area, the ladder being received within the ladder enclosure, wherein the ladder receiving area is sized to permit the side rails and rungs of the ladder to pass therethrough along the height of the ladder, and the ladder support area comprises side rail receptacles defined on either side of the ladder rung engagement by the rear support and the side supports, the side rail receptacles being open to the ladder receiving area and sized to receive the side rails of the ladder such that one of the rungs of the ladder directly overlies the ladder rung engagement, wherein the ladder is inserted through the ladder receiving area, and is movable into the ladder support area from the ladder receiving area, and a mounting element for mounting the ladder enclosure to a surface.

According to another aspect, the front of the ladder enclosure may comprise a front support.

According to another aspect, each of the front support and the rear support may be length-adjustable.

According to another aspect, the ladder rung engagement may comprise a section of the rear support that is offset into the ladder enclosure.

According to another aspect, the mounting element may permit pivotal movement of the ladder enclosure relative to the surface.

According to an aspect, there is provided a method of erecting a ladder against a surface, the ladder having side rails connected by rungs spaced along a height of the ladder, the method comprising the steps of mounting a ladder enclosure to the surface, the ladder enclosure having a front, side supports, a rear support, and a ladder rung engagement that extends from the rear support toward the front, the ladder enclosure defining a ladder receiving area and a ladder support area, the ladder support area comprises side rail receptacles defined on either side of the ladder rung engagement by the rear support and the side supports, the side rail receptacles being open to the ladder receiving area and sized to receive the side rails of the ladder, inserting the ladder into the ladder receiving area of the ladder enclosure such that a top section of the rails and at least one rung passes therethrough, moving the ladder from the ladder receiving area into the ladder support area, and lowering the ladder relative to the ladder enclosure until one of the rungs directly overlies the ladder rung engagement.

According to another aspect, the front of the ladder enclosure may comprise a front support.

According to another aspect, each of the front support and the rear support may be length-adjustable.

According to another aspect, the ladder rung engagement may comprise a section of the rear support that is offset into the ladder enclosure.

According to another aspect, the mounting element may permit pivotal movement of the ladder enclosure relative to the surface.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a ladder safety device retaining a ladder.

FIG. 2 is a side elevation view of the ladder safety device of FIG. 1 attached to a roof and retaining a ladder.

FIG. 3 is a side elevation view of the ladder safety device of FIG. 1 attached to a roof and receiving a ladder.

FIG. 4 is a top perspective view of a ladder safety device having an adjustable width and length.

FIG. 5 is a top perspective view of the ladder safety device of FIG. 3 adjusted to a different width.

FIG. 6 is an exploded top perspective view of the ladder safety device of FIG. 3 with attachment brackets shown.

### DETAILED DESCRIPTION

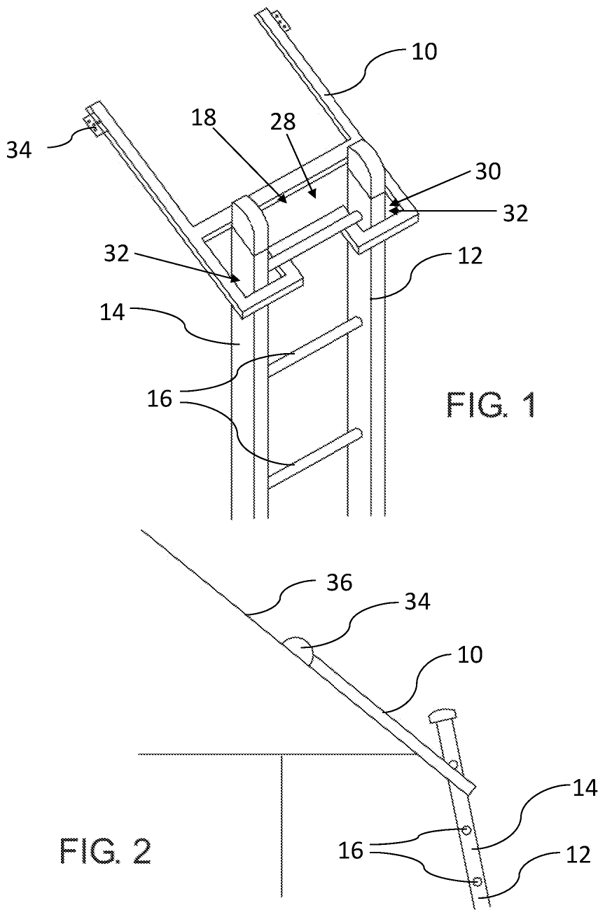

A ladder safety device generally identified by reference numeral 10 will now be described with reference to FIG. 1 through 6.

Referring to FIG. 1, ladder safety device 10 supports a ladder 12, which has side rails 14 connected by rungs 16 spaced along the height of ladder 12. It will be understood that ladder safety device 10 may be used with a variety of types of ladders, the construction of which is well understood by those skilled in the art.

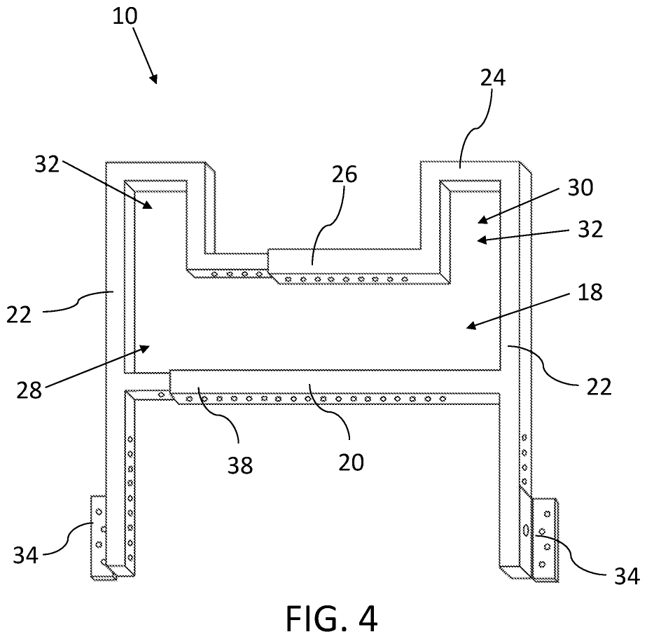

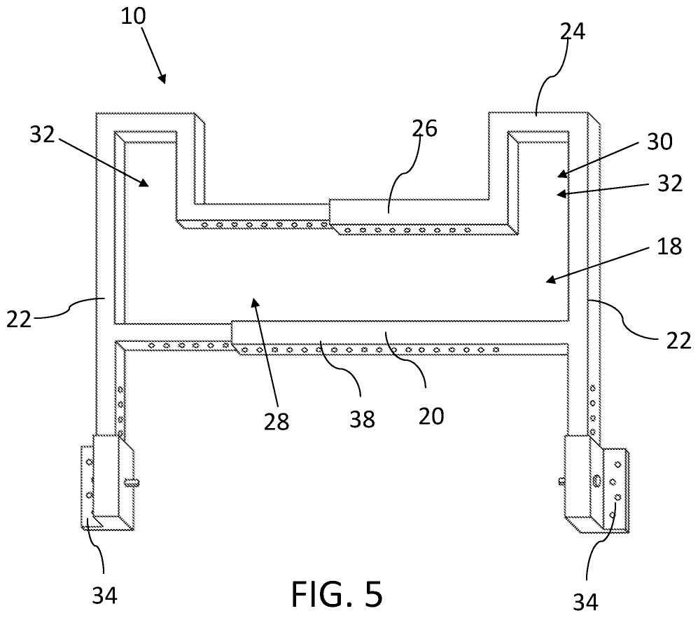

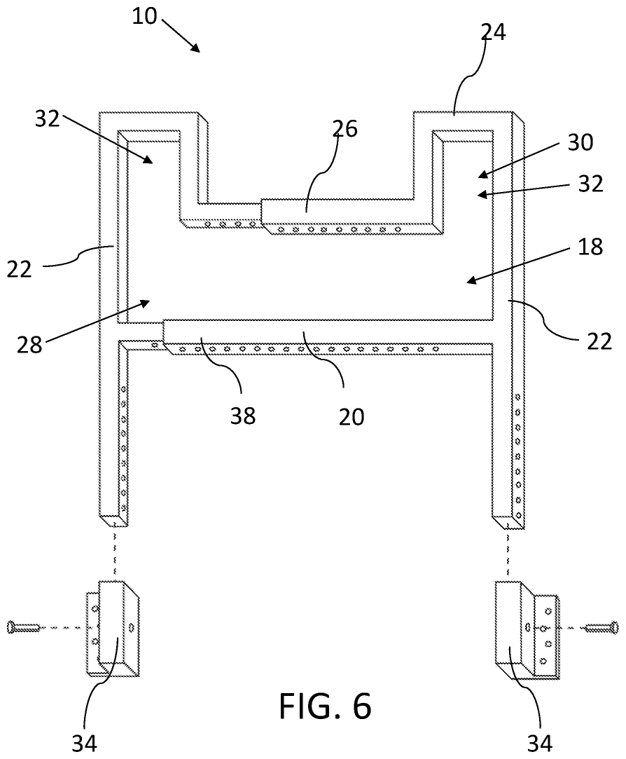

Referring to FIG. 4, ladder safety device 10 has a ladder enclosure 18 with a front 20, side supports 22, and a rear support 24. As shown, front 20 of ladder enclosure 18 has a front support 38. However, it will be understood that front 20 of ladder enclosure 18 may be open, and ladder 12 may be supported from forward movement by engaging with a surface 36, as would happen if ladder 12 were placed against surface 36 without the use of ladder safety device 10. Referring to FIG. 4 and FIG. 5, front support 38 and rear support 24 may be length adjustable. Referring to FIG. 6, side supports 22 may also be length adjustable. Depending on the application for ladder safety device 10, it will be apparent that front support 38, rear support 24, and side supports 22 may also be a standard length to accommodate a given ladder or a variety of types of ladders. By providing length-adjustable side supports 22, ladder safety device 10 may also be used on an angled roof, where side supports 22 may be lengthened to accommodate for the change in the effective width relative to ladder 12.

Referring to FIG. 4, ladder enclosure 18 has a ladder rung engagement 26 that extends from rear support 24 toward front 20. As shown in FIG. 4, ladder rung engagement 26 is formed from a section of rear support 24 that is offset into ladder enclosure 18. However, it will be understood that rear support 24 may extend across the rear of ladder enclosure 18, and ladder rung engagement 26 may be a separate component attached to and extending from rear support 24, or integrally formed with rear support 24. For example, rear support 24 may be a continuous piece along the rear of ladder enclosure 18, with a ladder rung engagement 26 welded onto rear support 24.

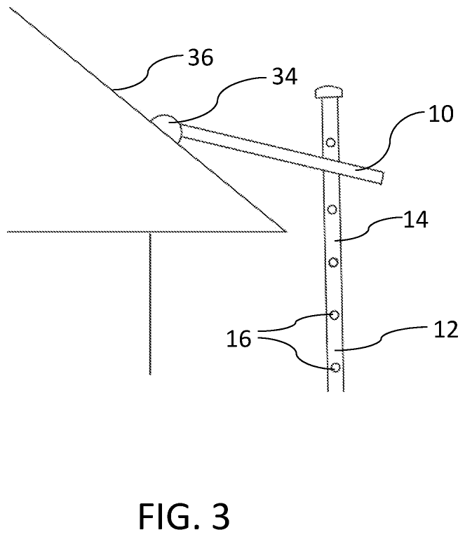

Referring to FIG. 1, ladder enclosure 18 defines a ladder receiving area 28 and a ladder support area 30. Ladder receiving area 28 is sized to permit side rails 14 and rungs 16 of ladder 12 to pass therethrough along the height of ladder 12. Ladder support area 30 has side rail receptacles 32 defined on either side of ladder rung engagement 26 by rear support 24 and side supports 22. Side rail receptacles 32 are open to ladder receiving area 28 and are sized to receive side rails 14 of ladder 12 such that one of the rungs 16 of ladder 12 directly overlies ladder rung engagement 26. Referring to FIG. 3, ladder support area 30 is accessed by inserting ladder 12 through ladder receiving area 28 and moving ladder 12 into ladder support area 30 from ladder receiving area 28. Ladder safety device 10 has a mounting element 34 for mounting ladder enclosure 18 to a surface 36. As shown in FIG. 2 and FIG. 3, mounting element 34 may allow for pivotal movement of ladder enclosure 18 relative to surface 36.

Referring to FIG. 3, in order to erect ladder 12 against surface 36, ladder enclosure 18 is mounted to surface 36 using mounting elements 34. For example, when mounting elements 34 are brackets pivotally attached to ladder enclosure 18, the brackets may be fixed into the surface using screws. Ladder 12 can then be inserted into ladder receiving area 28 so that a top section of rails 14 and at least one of the rungs 16 passes through ladder receiving area 28. The ladder 12 can then be moved from the ladder receiving area 28 into the ladder support area 30, such as by angling ladder 12 away from structure 36. Ladder 12 can then be lowered relative to ladder enclosure 18 until one of the rungs 16 that had previously passed through ladder receiving area 28 directly overlies ladder rung engagement 26. Ladder enclosure 18 and ladder 12 then rest together against the structure 36 as shown in FIG. 2. Referring to FIG. 1, when ladder 12 is installed within ladder enclosure 17, it is prevented from movement in multiple directions. Front support 38 or structure 36 prevent ladder 12 from moving forward. Rear support 24 prevents ladder 12 from moving backward. Side supports 22 prevent the ladder from falling to either side. As well, ladder rung engagement 26 limits side to side movement of ladder 12. Ladder rung engagement 26 also prevents accidental slippage or removal of ladder 12 from ladder enclosure 18. The engagement between ladder rung engagement 26 and rung 16 prevents ladder 12 from moving downwards once ladder 12 had been moved from ladder receiving area 28 into ladder support area 30. In order to disengage ladder 12 from ladder enclosure 18, ladder 12 is moved back into ladder receiving area 28, from which it can be pulled downward and out of ladder enclosure 18.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A method of erecting a ladder against a surface, the ladder having side rails connected by rungs spaced along a height of the ladder, the method comprising the steps of:
mounting a ladder safety device to the surface by fixedly attaching a mounting element to the surface, the ladder safety device comprising a ladder enclosure that defines a continuous enclosed perimeter completely around a latter receiving area, the ladder enclosure having a front support, side supports, a rear support, and a ladder rung engagement that is spaced from the side supports, the ladder receiving area being sized to receive the side rails and rungs of the ladder;
inserting a leading end of the ladder into the ladder receiving area of the ladder enclosure such that a portion of the ladder safety device pivots relative to the mounting element from a support position to a receiving position that permits a top section of the rails and at least one rung to pass therethrough and thereafter permitting the portion of the ladder safety device to return to the receiving position; and
with the portion of the ladder safety device in the receiving position below the at least one rung, lowering the ladder relative to the ladder enclosure until one of the rungs directly overlies the ladder rung engagement such that the ladder rung engagement supports a weight of the ladder and prevents relative withdrawal movement of the ladder with respect to the ladder safety device.

2. The method of claim 1, wherein each of the front support and the rear support are length-adjustable.

3. The method of claim 1, wherein the ladder rung engagement comprises a section of the rear support that is offset into the ladder enclosure.

4. The method of claim 1, wherein the mounting element permits pivotal movement of the ladder enclosure relative to the surface.
